(19) United States
(12) Patent Application Publication
(10) Pub. No.: US 2004/0055194 A1
(43) Pub. Date: Mar. 25, 2004

(54) Sign post end protector

(76) Inventors: Dee Dee Mock Wilson, Colorado Springs, CO (US); Charles A. Wilson, Colorado Springs, CO (US)

Correspondence Address: HANES & SCHUTZ, P.C., 102 S. TEJON ST., SUITE 800, COLORADO SPRINGS, CO, 80903, US

(21) Appl. No.: 10/236,725

(22) Filed: Sep. 6, 2002

(51) Int. Cl. G09F 15/00

(52) U.S. Cl. 40/607.05

(57) ABSTRACT

Apparatus for shielding the hazardous pointed bottom or damaged top ends of leg members that depend from an article, such as a yard sign, comprising, a plurality of open-ended receptacles, each having a sidewall with a peripheral rim and being interconnected by a flexible cord of variable length that is trained over a portion of the article to provide restraining force to maintain the receptacles in position covering one or more ends of the legs. A method of attaching the apparatus is also disclosed.

### FIELD OF THE INVENTION

The present invention relates to a device for temporarily shielding the pointed ends of the stakes that support a transportable yard sign.

### BACKGROUND OF THE INVENTION

Yard signs typical of those advertising real estate properties “For Sale” have a traditional construction that comprises a display panel having one or more depending leg-forming stakes. The distal ends of the legs are pointed in order to facilitate driving the legs into the ground as a support for the sign or other object being supported by the legs. Signs of this type are transportable and are usually carried in the trunk or interior of an automobile.

In handling, carrying, loading and transporting these signs, several safety issues are presented. The pointed ends of the stake-legs can be injurious to the people who handle or are in close proximity to the signs when they are being carried from place to place. Moreover, regardless of the care exercised, the pointed ends of the legs invariably damage the interior of the vehicles in which they are carried.

It is therefore the primary object of the present invention to protect persons and property from injury and damage arising from unintentional injurious contact with the pointed end found on the leg of a typical reusable yard sign.

It is also an object of the invention to provide a safety guard for the pointed ends of other kinds of objects.

### SUMMARY OF THE INVENTION

While the preferred form of the invention is configured to protect the pointed ends of the legs of a typical transportable real estate yard sign, the structure of the invention can easily be modified to serve as a protective guard for other sharp or pointed objects.

Because the traditional real estate yard sign has a pair of spaced apart legs having sharp pointed distal ends, the protective apparatus of the present invention is preferably constructed to accomplish the purposes of the invention with respect to such a sign. A flexible retention cord, having an adjustable length, interconnects two cups or receptacles. In operation, one of the cups is placed over the pointed end of each leg and the interconnecting retention cord is trained from the cups over a horizontal structural member of the sign to provide a retaining force to maintain each of the cups in position around the pointed ends of the legs. Preferably, the retaining cord is adjustable in its length to accommodate signs of differing dimensions. The receptacles may be sized and dimensioned so as to be nestable, one into the other, for storage purposes.

### DESCRIPTION OF THE DRAWINGS

FIG. 1 is a side view of a typical yard sign to which the apparatus of the present invention is applicable.

FIG. 2 is a side view of a typical yard sign showing an application of the apparatus of the present invention to protect persons and property from the pointed end of a sign leg and also the sharp edges of the top end of the leg.

FIG. 3 is an enlarged prospective view of a pair of the protective cups of the present invention and showing the interconnecting retention cord.

FIG. 4 is a cross sectional view of a protective cup-receptacle taken along lines 4-4 in FIG. 3 and illustrating a preferred form of the structure for interconnecting the retention cord and the cup.

FIG. 5 is a rear view of the application of the invention to a reusable yard sign having only one leg-forming stake.

13 FIG. 6 is an enlarged side view of the protective cups of the present invention in a partially nested position for storage. The retention cord is not shown.

### DETAILED DESCRIPTION OF THE INVENTION

As shown in FIG. 1, a typical yard sign 3 comprises a pair of stake-legs 4 and 6 that support one or more panels that contain a sign or other some other species of article. Each of the legs 4 and 6 is provided with a pointed distal end to ease the driving of the stake-legs into the ground for supporting the sign or article. When moving or transporting the sign 3 to or from its appointed field location the pointed distal ends of the legs 4 and 6 present a potentially injurious feature. In addition to the pointed distal leg ends the top ends of the legs also present injurious possibilities, since the extended top leg ends receive severe treatment from repeated hammer blows rendered to drive the stake-legs into the ground. The top end of the typical metal leg becomes flattened with protruding sharp metal edges.

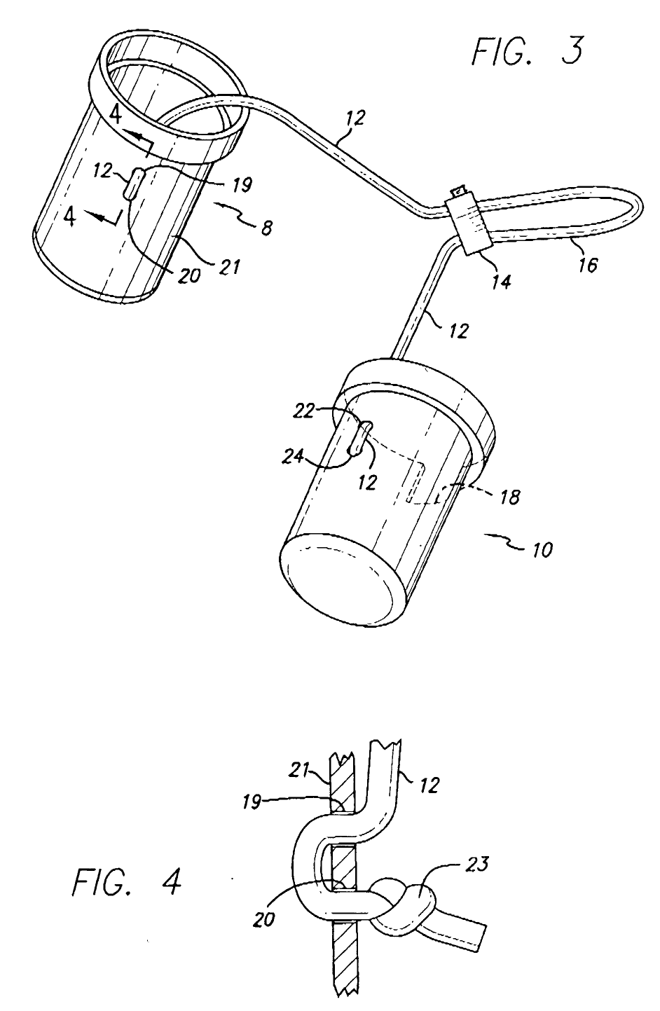

In order to guard persons and property from injury or damage caused by contact with the pointed leg ends or the sharp edges on the top end of the leg the present invention provides a pair of guard receptacles that are preferably formed in the shape of cups or open ended containers 8 and 10, as seen best in FIG. 3. The purpose of the receptacles 8 and 10 is to house and shield the hazardous ends of the legs 4 and 6 of a sign or similar article while the article is being handled, transported or stored.

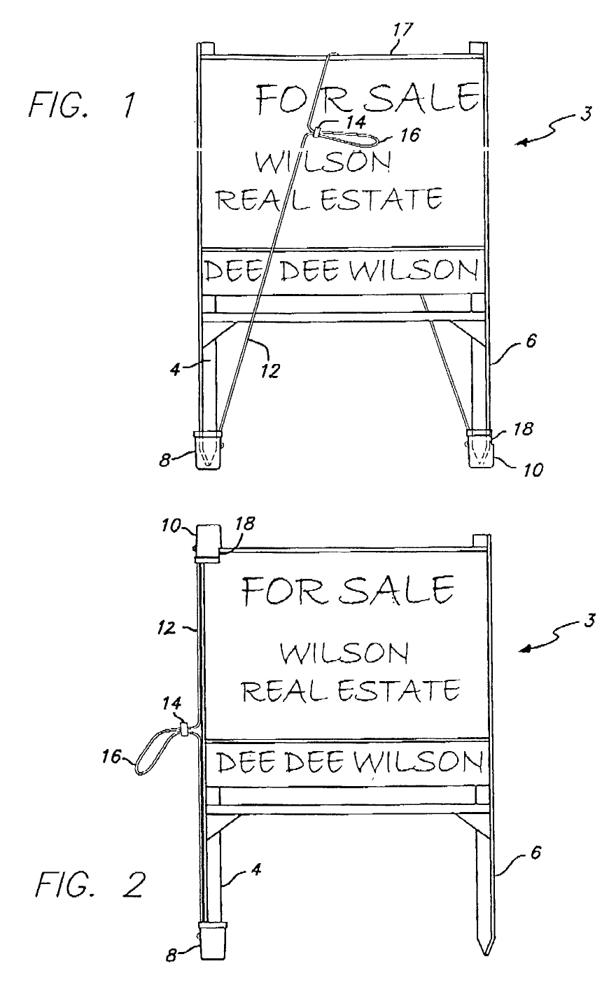

FIGS. 1, 2 and 5 illustrate the application of the protective cups to the legs of a transportable reusable yard sign. In FIG. 1 a pair of cups 8 and 10 are employed to guard the pointed distal ends of the legs. FIG. 2 shows how a pair of the protective cups of the invention may be used to guard both the deformed top and the pointed bottom end of a single sign leg. Obviously two pair of the protective receptacles could guard both top and bottom of both legs.

Merely placing the receptacles over the hazardous ends of the legs would be meaningless unless there was a means to retain them in place. According to the present invention, a length of flexible cord 12 interconnects the receptacles 8 and 10 to provide the retaining force necessary to maintain the receptacles in their covering positions. By training the central portion of the cord over a horizontal structural member 17 of the sign (FIG. 1) and causing the cord 12 to be taught, a force is exerted on each of the receptacles that tends to pull each receptacle toward the leg whose point is introduced into the receptacle, thus maintaining each cup in its protective place on the distal end of the leg. Because the articles to which the stake-legs may be attached will vary in size and will present different structural configurations with which the cord must make contact for establishing the necessary cord tension, the cord must be variable in its working length. The variability of the cord's length may be achieved in a number of different ways. The cord may be elastic, as a bungee cord, although the limit of elasticity may limit the possible length of the cord. Preferably, the cord is made long enough to serve all reasonably possible applications and the cord is provided with a selective stop 14 that is carried by a doubled back length of the cord 16. Such a construction permits the cord length to be suited to the particular application. After the ends of the legs 4 and 6 are introduced into the receptacles 8 and 10 and the cord is positioned over the horizontal structural member 17 of the sign 2, as shown in FIG. 1, the cord is made taught by adjusting the size of the cord loop 16 and positioning the stop 14 to maintain that loop size, thus providing tension in the cord that is sufficient to cause its restraining force to be applied to the receptacles 8 and 10.

FIG. 2 illustrates a second use of the retaining cord 12 where the size of the loop 16 is adjusted and locked to provide a cord length that establishes a direct tension force between the cups 8 and 10 disposed on the top and bottom ends of the leg 4. A portion 18 of one of the cups 10 is cut out of the cup's sidewall to accommodate the panel structure of the sign when the cup is placed over the top end of the leg.

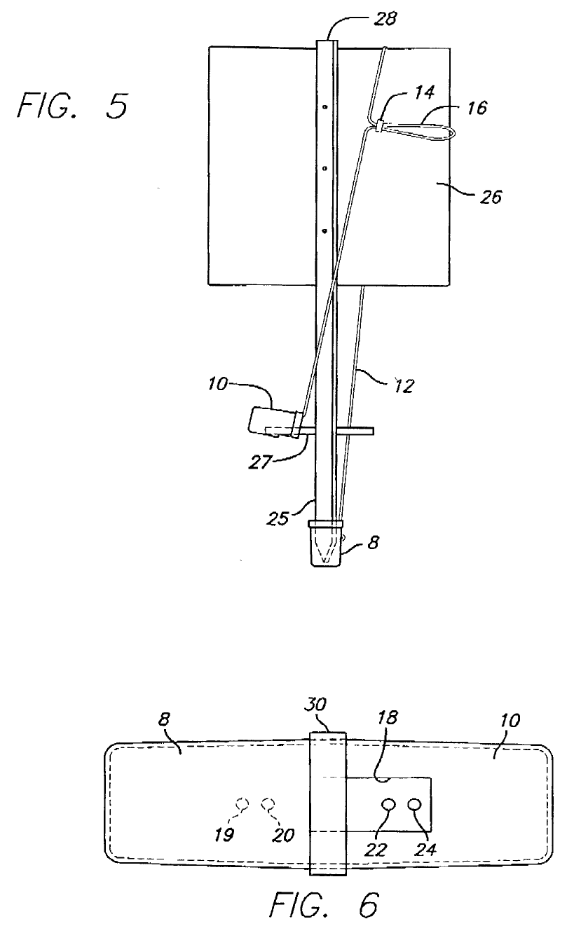

FIG. 5 illustrates one use of the apparatus with a sign having only one leg-forming stake. One of the cups 8 is placed in protective position over the pointed distal end of the sign leg 25. The cord 12 is trained over the top of the sign panel 26 and the other cup 10 may be positioned over the foot step 27 attached to leg. The cord 12 is tensioned, as in the other configurations, by adjusting the loop 16 and locking it in a fixed position with the cord lock 14. If the foot step was not present or if it was desired to shield the upper end 28 of the sign leg 25, the second cup 10 could be positioned over that upper end and the cord 12 would be tensioned in the same fashion as shown in FIG. 1.

There are several ways of fastening the ends of the cord 12 to the receptacles but the preferred form is shown in FIGS. 3 and 4. A pair of spaced apart apertures 19 and 20 in the sidewall 21 of the first receptacle 8 is provided to anchor one end of the cord 12. The end of the cord is trained from the inside of the receptacle through the top most aperture 19, across a portion of the outside surface of the sidewall 21 and back through the lower aperture 20. A knot 23 is tied in the cord that prevents the end of the cord from being pulled back through the aperture 20. Similar apertures 22 and 24 in the second receptacle 10 anchor the other end of the cord 12 in the same manner as that described for the first receptacle 8.

Preferably, the container cups 8 and 10 are sized and dimensioned so that, for storage purposes, the cups may be nested end to end, as shown in FIG. 6. One of the cups 8 is provided with an enlarged circumferential flange 30 around its open top end that defines a collar into which the top open end of the other cup 10 is inserted. The rim 31 of the inserted cup 10 abuts against the top rim 33 of the housing cup 8. Although not shown for clarity in FIG. 6, the retaining cord 12 is coiled or folded and stored within the interior space of the abutted and partially nested cups 8 and 10.

What is claimed is:

1. Apparatus for shielding the hazardous ends of at least one stake-leg member that depends from an article, comprising,
a plurality of open-ended receptacles each having a sidewall with a peripheral rim and being interconnected by a flexible cord of variable length.

2. The apparatus of claim 1 where the cord is elastic.

3. The apparatus of claim 1 where the cord includes a cord stop carried on a doubled back loop-forming portion of the cord that acts to adjust the length of the cord.

4. The apparatus of claim 1 where the receptacles are open end to open end nestable, one into the other.

5. The apparatus of claim 1 where the sidewall of each receptacle has at least one aperture through which the cord is trained for attachment to the receptacle.

6. The apparatus of claim 1 where the sidewall of at least one receptacle is relieved to form a notch with an opening at the rim.

7. Apparatus for shielding the hazardous ends of at least one stake-leg member that depends from a transportable yard sign, comprising,
a plurality of open-ended receptacles each having a sidewall with a peripheral rim and having at least one aperture in the sidewall;
a flexible cord of variable length passing through the at least one aperture in each receptacle for interconnecting the receptacles and having a loop formed by a double backed portion of the cord,
a cord stop carried on the doubled back loop-forming portion of the cord that acts to adjust the length of the cord.

8. The apparatus of claim 7 where the sidewall of at least one receptacle is relieved to form a notch with an opening at the rim.

9. A method of shielding the pointed distal ends of a plurality of vertically disposed legs depending from an article having at least one horizontal structural member, including the steps of:
introducing the pointed end of a first one of the legs into a first protective receptacle;
introducing the pointed end of a second one of the legs into a second protective receptacle;
training the mid portion of a variable length retention cord that interconnects the first and second receptacles over the at least one horizontal member of the article; and
adjusting the length of the cord so as to make the cord taught to provide tension in the cord and a resultant retention force applied to each of said receptacles to maintain each receptacle in its respective place, covering the pointed end of each leg.

10. A method of shielding the upper and lower exposed hazardous ends of a metal leg member, including the steps of:
introducing the upper end of the leg member into a first protective receptacle;
introducing the lower end of the leg member into a second protective receptacle;
adjusting the length of a variable length retention cord that interconnects the first and second receptacles to make the cord taught so as to tension in the cord and provide a resultant biasing force applied to each of said receptacles to retain each receptacle in its respective place, covering the ends of the leg.
